(19) United States
(12) Patent Application Publication
(10) Pub. No.: US 2006/0101367 A1
(43) Pub. Date: May 11, 2006

(54) Design method of semiconductor device and semiconductor device

(75) Inventors: Kazuhisa Fujita, Kyoto (JP); Fumihiro Kimura, Nara (JP); Takayuki Araki, Osaka (JP)

Correspondence Address: PANASONIC PATENT CENTER;c/o MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD.

(21) Appl. No.: 11/262,966

(22) Filed: Nov. 1, 2005

(30) Foreign Application Priority Data
Nov. 8, 2004 (JP) 2004-323566

(51) Int. Cl. G06F 17/50; G06F 9/45; G06F 9/455

(52) U.S. Cl. 716/10; 716/11; 716/2

(57) ABSTRACT

In an error analysis step, analysis of an antenna effect error, a timing constraint violation and the like is performed for layout data in which redundant via conversion has been performed. Then, whether or not an error exists is judged and, among redundant vias located on a signal line in which a design constraint violation has occurred, how many vias have to be converted to single vias, respectively, to avoid the design constraint violation is calculated. In a via conversion step, a redundant via which has caused an error is converted to a single via, based on a result of the calculation. Thus, a design constraint violation regarding an error such as an antenna effect error and a timing constraint violation caused by a redundant via obtained by converting a single via for improving yield hardly occurs.

### CROSS REFERENCE TO RELATED APPLICATIONS

This non-provisional application claims priority under 35 U.S.C. § 119(a) on Patent Application No. 2004-323566 filed in Japan on Nov. 8, 2004, the entire contents of which are hereby incorporated by reference.

### BACKGROUND OF THE INVENTION

The present invention relates to a design method of a semiconductor device and a semiconductor device which allow avoidance of violation of design constraints such as an antenna effect error and the like and insertion of as many redundant vias as possible in consideration of a yield, influences of electromigration and the like.

In the recent miniaturization process, it is difficult to achieve a miniaturized design pattern with high accuracy in fabricating an LSI. This results in reduction in yield.

The problem of reduction in yield can be improved by converting a single via connecting wiring patterns in different wiring layers to a set of two or more vias (the set of two or more vias will be referred to as a “redundant via”) as many as possible (this process will be called redundant via conversion). With redundant via conversion, a wire connection in which the probability of occurrence of an inconvenience is low can be achieved.

Now, a general semiconductor layout step for conducting redundant via conversion and a known redundant via conversion step achieved by improving the general semiconductor layout step will be described with reference to FIG. 8.

In FIG. 8, the reference numeral 801 denotes circuit connection information, the reference numeral 802 denotes a wire formation rule and the reference numeral 803 denotes a library of standard cells and macro cells such as a SRAM, a DRAM and an input/output cell. The reference numeral S804 denotes the layout step of placing a library of standard cells and macro cells such as a SRAM, a DRAM and an input/output cell based on the circuit connection information 801.

A subsequent step, i.e., Step S805 is the global routing step of roughly determining a path of a wiring pattern which connects a standard cell and a macro cell, based on a result of the placing step S804 and the circuit connection information 801. The reference numeral S806 denotes the detail routing step of connecting, based on a result of the global routing, wires using a wiring pattern, single vias and redundant vias so that the wire formation rule 802 regarding spacing and the like can be completely satisfied. In the detail routing step S806 which is a general semiconductor layout step, wiring patterns are connected by a single via unless the wire formation rule 802 includes the definition that a wire having a minimum line width and two or more vias have to be used for connecting wires or the like. Accordingly, there might be cases where redundant via conversion is not sufficiently performed.

To cope with the above-described problem, for example, in a known technique shown in U.S. Pat. No. 6,026,224, U.S. Pat. No. 6,556,658 or NIKKEI MICRODEVICE, Sep. 1, 2003, PP. 46-51, redundant via conversion is performed to a result obtained from the detail routing step S806 in the manner shown in FIG. 8. In this redundant via conversion, each of single vias which satisfy the wire formation rule 802, in other words, single vias which do not violate spacing rules of wires and their resultant redundant vias from redundant via conversion is converted to a redundant via in the redundant via conversion step S807. As described above, techniques which allow redundant via conversion of as many vias as possible have been proposed by many EDA vendors and the like. Moreover, some EDA vendors have taken a further step and provides a tool using a technique in which the number of single vias to be converted to respective redundant vias is increased, even when wire formation rule violation occurs, by converting each of single vias to a redundant via and then correcting a wire layout so that the wire formation rule 802 is satisfied.

In redundant via conversion described in U.S. Pat. No. 6,556,658, a single via which might cause a timing error is not converted to a redundant via.

It is described in EDN Japan, February, 2004, that when a current density of a current flowing in a single line is exceedingly increased, electromigration which results in the generation of a hollow in a wire or short-circuit or cut-off of a wire due to migration of metal ions occurs. As a method for avoiding such electromigration, a technique in which a width of a wire is increased to reduce a resistance of a wire and a technique in which each of single vias on a wire path is converted to two or more vias are well known.

However, in a known method, if redundant via conversion is performed to suppress reduction in fabrication yield due to electromigration, a violation of a specific constraint are increased. The present inventor examined details of the above-described problem and found that an antenna effect occurs due to increase in the number of redundant vias. The antenna effect will be specifically described. When a wire or a via is formed on a silicon wafer by plasma etching, charges are stored in the wire or the via. Therefore, when a wire connected to a gate in a transistor is not grounded, stress is imposed on a gate oxide film by stored charges, so that an antenna effect which breaks down the gate oxide film is caused if a total wire area or a total via area is large.

As described above, due to a redundant via generated by conversion for improving problems with yield or electromigration, an antenna effect error occurs. Therefore, as a method for avoiding the above-described antenna effect, it is desired that the total area of wires connecting to a gate or the total area of vias is reduced to a small value while the above-described redundant via conversion for dealing with problems with yield and electromigration is performed. That is, it is desired that a wire length is shortened and the number of vias is reduced.

Moreover, assume the case where a timing error is not taken into consideration. Due to conversion of each of single vias to a redundant via, a resistance value of a wire to which the vias belong fluctuates and another timing constraint violation newly occurs. As a result, major design modification might be imposed. However, even though timing constraints are taken into consideration, in the case where a timing constraint violation might occur, as in U.S. Pat. No. 6,556,658, a method in which all vias are maintained as signal vias, i.e., single vias of which respective resultant redundant vias would not cause any problem are also left as single vias is not a sufficient measure for preventing reduction in yield.

### SUMMARY OF THE INVENTION

According to the present invention, as many redundant vias as possible are inserted so that violations of a design constraint rule, except for a wire formation rule, such as an antenna effect error, a timing constraint violation and the like, can be avoided and a yield and a problem due to electromigration can be improved.

Specifically, according to the present invention, layout data including redundant vias is analyzed to seek a redundant via(s) which causes a predetermined constraint violation, e.g., an antenna effect error. Based on a result of the analysis, the number of redundant vias with which a problem due to such a design constraint violation can be avoided is calculated. If arrangement of redundant vias has been completed, the number of redundant vias is reduced to the number thereof with which such a problem can be avoided. In the step of performing layout of a wire in which conversion from a single via to a redundant via is not performed or layout of single vias, a layout in which as many redundant vias as possible are provided until the number of provided redundant vias reaches the number with which such a problem in consideration of a timing constraint can be avoided is designed by computer.

Therefore, a method for designing a semiconductor device according to the present invention is directed to a semiconductor device design method for designing by computer a layout of a semiconductor device including redundant vias each of which is obtained by converting each of single vias each connecting wires in different wiring layers to two or more vias and characterized by including: a judgment step of performing judgment of whether or not a predetermined constraint violation caused by each of the redundant vias exists to layout data including the redundant vias; a calculating step of calculating, if it is judged that the predetermined constraint violation exists in the layout data in the judgment step, a minimum conversion via number of the redundant vias to be converted to the respective single vias so that the predetermined constraint violation is resolved; and a conversion step of converting ones of the redundant vias to ones of the single vias, respectively, according to the conversion via number obtained in the calculating step.

In one embodiment of the present invention, the semiconductor device design method is characterized in that in the conversion step, ones of the redundant vias belonging to the layout data in which the predetermined constraint violation has occurred are detected and then converted to the single vias, respectively, one by one, in the order of the detection.

In one embodiment of the present invention, the semiconductor device design method is characterized in that arbitrary vias are selected from all the redundant vias at random so that the number of the selected redundant vias corresponds to the conversion via number calculated in the calculating step and then the selected redundant vias are converted to ones of the single vias, respectively, one by one.

In one embodiment of the present invention, the semiconductor device design method is characterized in that in the conversion step, based on the conversion via number calculated in the calculating step, conversion to a single via is repeatedly performed to the redundant vias in each signal line including the redundant vias until the predetermined constraint violation no longer exists.

In one embodiment of the present invention, the semiconductor device design method is characterized in that the inventive method further includes a redundant via priority determination step of assigning priorities to all of the redundant vias in the conversion step in descending order of a necessity of redundant via conversion, and in the conversion step, conversion to a single via is performed to the redundant vias in ascending order of the priories assigned in the redundant via priority determination step.

In one embodiment of the present invention, the semiconductor device design method is characterized in that in the redundant via priority determination step, among the redundant vias, a redundant via located a longer distance from another redundant via is given a lower priority.

In one embodiment of the present invention, the semiconductor device design method is characterized in that in the redundant via priority determination step, among the redundant vias, a redundant via located on a wire in which the number of the occurrence of electromigration is smaller is given a lower priority.

In one embodiment of the present invention, the semiconductor device design method is characterized in that the redundant via priorities are input from the outside, and in the redundant via priority determination step, the redundant via priorities input from the outside are assigned to all of the redundant vias.

In one embodiment of the present invention, the semiconductor device design method is characterized in that the redundant via priorities are stored in advance in a program code in computer, and in the redundant via priority determination step, the redundant via priorities stored in the program code in the computer are assigned to all of the redundant vias.

Another method for designing a semiconductor device according to the present invention is directed to a semiconductor device design method for designing by computer a layout of a semiconductor device including redundant vias each of which is obtained by converting each of single vias each connecting wires in different wiring layers to two or more vias, and is characterized by including: a virtual conversion step of virtually converting ones of the single vias to ones of the redundant vias, respectively; a calculating step of calculating, for the layout data obtained in the virtual conversion step and including the redundant vias, a convertible number of the redundant vias which can be converted from the single vias, respectively, without causing a predetermined constraint violation; and a conversion step of generating, based on the convertible number of the redundant vias obtained in the calculating step, the redundant vias by conversion of the single vias.

Still another method for designing a semiconductor device according to the present invention is directed to a semiconductor device design method for designing by computer a layout of a semiconductor device including redundant vias each of which is obtained by converting each of single vias each connecting wires in different wiring layers to two or more vias, and is characterized by including: a calculating step of calculating, for the layout data including the single vias, a convertible number of the redundant vias which can be converted from respective single vias without causing a predetermined constraint violation; a single via priority determination step of assigning priorities to all of the single vias corresponding to the convertible number calculated in the calculating step in descending order of a necessity of redundant via conversion; and a conversion step of performing redundant via conversion to the single vias in descending order of priority determined in the single via priority determination step.

In one embodiment of the present invention, the semiconductor device design method is characterized in that in the single via priority determination step, each time when a single via is generated, a single via priority is assigned to the single via during detail routing performed to post-global-routing layout data.

A semiconductor device according to the present invention is characterized in that the semiconductor device is fabricated according to any one of the inventive semiconductor device design methods.

As has been described, according to each of the semiconductor device design method of the present invention, for example, in a judgment step, it is judged whether or not a predetermined constraint violation due to a redundant via which is converted from a single via exists. Then, based on a result of the judgment, a conversion number with which the predetermined constraint violation is resolved is calculated, and redundant vias are converted to single vias in order until the number of the converted vias reaches the conversion number. Thus, as many redundant vias as required for resolving a cause of the occurrence of electromigration and reduction in yield can be provided without causing a predetermined constraint violation such as an antenna effect error.

Specifically, according to the present invention, a redundant via provided in a location where a single via causes a problem at a high probability, e.g., a redundant via located at a short distance from another redundant via or a single via which causes reduction in yield or a redundant via located on a wire in which the incidence of electromigration is large, is given a higher priority. Then, redundant vias are converted to single vias, respectively, in descending order of priority. Thus, while a predetermined constraint violation such as an antenna effect error is taken into consideration, redundant vias can be efficiently provided. Accordingly, a cause of a problem due to an arrangement of a single via, e.g., reduction in yield and the occurrence of electromigration can be removed.

Also, according to the present invention, for example, virtual conversion from single via to redundant via is performed before single vias are converted to redundant vias, respectively. In a judgment step, it is judged whether or not a predetermined constraint violation is to occur due to redundant vias provided through the virtual conversion. Then, based on a result of the judgment, a convertible number, i.e., the number of redundant vias to be converted to respective single vias with which the predetermined constraint violation is resolved is calculated. A corresponding number of redundant vias to the convertible number are converted to respective single vias, so that, for example, as many redundant vias as possible can be provided while not only an antenna effect error but also a timing constraint violation or another predetermined constraint violation are taken into consideration. Accordingly, a cause of the occurrence of electromigration and reduction in yield can be resolved.

Specifically, according to the present invention, a single via provided in a location where a single via causes a problem at a high probability, e.g., a single via located at a short distance from a redundant via or another single via which causes reduction in yield or a single via located on a wire in which the incidence of electromigration is large, is given a higher priority. Then, single vias are converted to redundant vias, respectively, in descending order of priority. Thus, while a predetermined constraint violation such as an antenna effect error and a timing constraint violation is taken into consideration, redundant vias can be efficiently provided. Accordingly, a cause of a problem due to an arrangement of a single via, e.g., reduction in yield and the occurrence of electromigration can be removed.

Furthermore, in the semiconductor device of the present invention, for example, within a range where a predetermined constraint violation such as an antenna effect error and a timing constraint violation, each redundant via is provided in part in which a cause of reduction in yield and the like are removed by conversion from a single via. That is, each redundant via is provided on a wire having a structure in which electromigration tends to occur at high probability. Thus, under the consideration of an antenna effect error and a timing constraint violation, reduction in yield and the occurrence of electromigration can be resolved most effectively.

### BRIEF DESCRIPTION OF THE DRAWINGS

FIG. 1 is a diagram illustrating process steps according to a first embodiment of the present invention.

FIG. 2 is a diagram illustrating process steps according to a second embodiment of the present invention.

FIG. 3 is a layout view illustrating priorities with respect to yield according to second, third and fifth embodiments.

FIG. 4 is a layout view illustrating priorities with respect to electromigration according to second, third and fifth embodiments.

FIG. 5 is a diagram illustrating process steps according to a third embodiment of the present invention.

FIG. 6 is a diagram illustrating process steps according to a fourth embodiment of the present invention.

FIG. 7 is a diagram illustrating process steps according to a fifth embodiment of the present invention.

FIG. 8 is a flowchart of process steps until known redundant via conversion in layout designing.

FIG. 9 is a layout view after known redundant via conversion.

FIG. 10 is a layout view illustrating a result obtained in the fourth embodiment.

FIG. 11 is a layout view illustrating a result obtained in each of the second and third embodiments.

### DESCRIPTION OF THE PREFERRED EMBODIMENTS

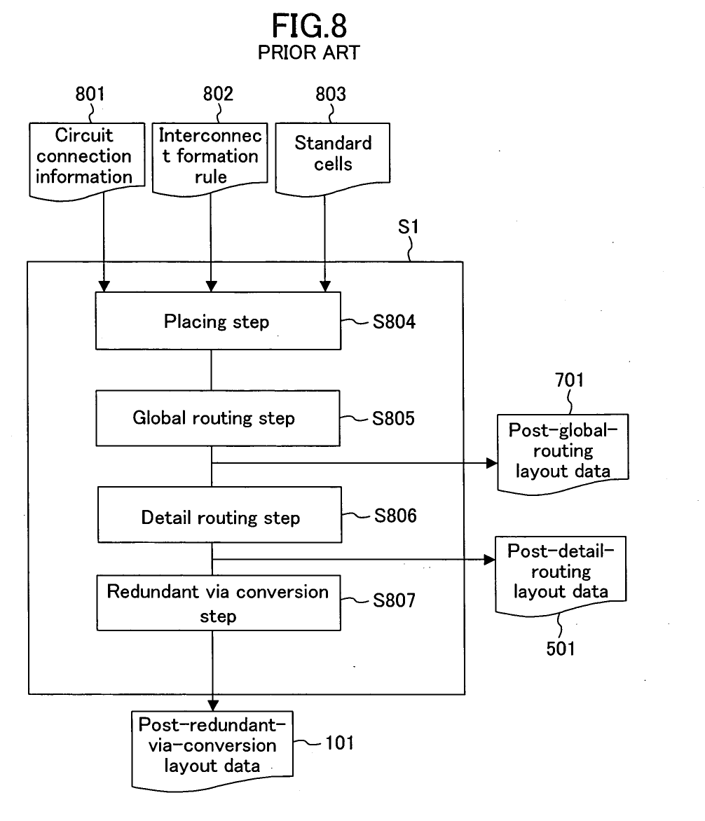

Hereinafter, preferred embodiments of the present invention will be described with reference to the accompanying drawings. Note that in each embodiment, each member also described in the known method described with reference to FIG. 8 is identified by the same reference numeral and therefore the description thereof will be omitted.

### FIRST EMBODIMENT

Hereinafter, a first embodiment of the present invention will be described with reference to the accompanying drawings.

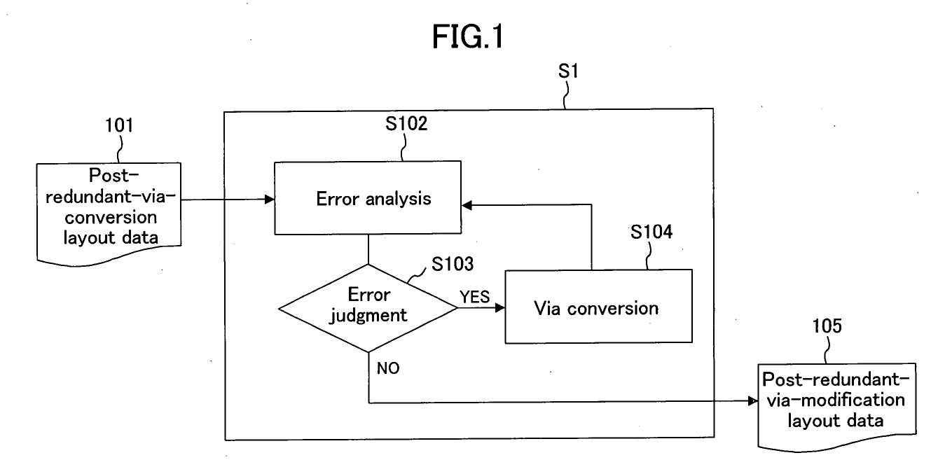

FIG. 1 is a diagram illustrating process steps performed by computer using a method for designing a semiconductor device according to the first embodiment of the present invention.

In FIG. 1, the reference numeral 101 denotes post-redundant-via-conversion layout data. Step S102 is the error analysis step of performing an error analysis for the post-redundant-via-conversion layout data 101 which has been input. Step S103 is the error judgment step of judging whether or not an error exists in a result of an error analysis of Step S102. Step S104 is the via conversion step of reconverting a redundant via to a single via when an error is found in the Step S103. The reference numeral 105 denotes layout data which is obtained after redundant via conversion and is to be output from the error judgment step S103 when an error is not found in the Step S103. The reference numeral 1 denotes the computer processing step including Step S102, Step S103 and Step S104.

Hereinafter, a method for designing a semiconductor device according to this embodiment which is used in the process steps set in the above-described manner will be described.

In the error analysis step S102, an analysis of design constraint rule violation (violation of a predetermined constraint) such as a violation of a timing constraint and an antenna effect error is performed to layout data obtained by inputting the post-redundant-layout data 101 after redundant via conversion in which a single via is converted to a set of two or more vias. Redundant via conversion is performed by providing an additional via(s) to a single via placed in part of a wire in which reduction in yield and electromigration tend to be caused, thus reducing a resistance value.

Next, in the error judgment step (judgment step) S103, whether or not the design constraint rule violation exists is judged. In the error judgment step S103, if it is judged that an error such as an antenna effect error has not occurred, the post-redundant-via-conversion layout data 105 is output as it is. Then, the post-redundant-via-conversion layout data 105 is output and the process is terminated. However, if it is judged that an error such as an antenna effect error has occurred, a redundant via reduction number (conversion number), i.e., the number of redundant vias which belong to a signal line and are to be converted to respective single vias to avoid a design constraint violation is calculated for each signal line, based on an error judgment result. In this embodiment, the error judgment step S103 includes the calculation step of calculating the redundant via reduction number.

Thereafter, in the via conversion step S104, redundant vias are converted to respective single vias in the order of detection of redundant vias which belong to the signal line in which an error has occurred or at random.

When the number of redundant vias which belong to a single line in which an error has occurred and have been converted to respective single vias reaches the redundant via reduction target number calculated for each signal line in the error judgment step S103 or all redundant vias which belong to the single line in which an error has occurred are converted to respective single vias, the process is terminated. In another case, the error analysis step S102 and then the error judgment step S103 are performed at each time when a redundant via is converted to a single via and then when an error no longer occurs, the process is terminated. In FIG. 1, the case where an error analysis in the error analysis step S102 and error judgment in the error judgment step S103 are performed each time when a redundant via is converted to a single via in the via conversion step S104 is shown.

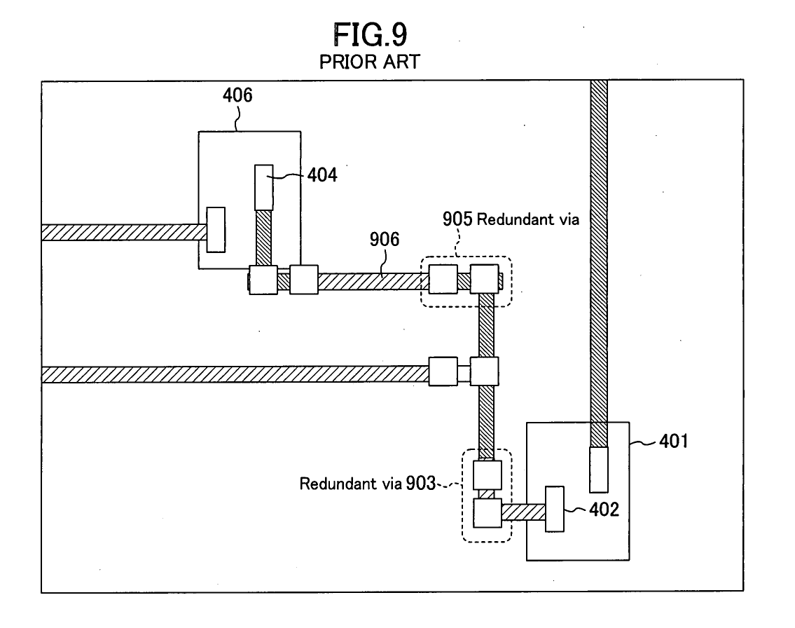

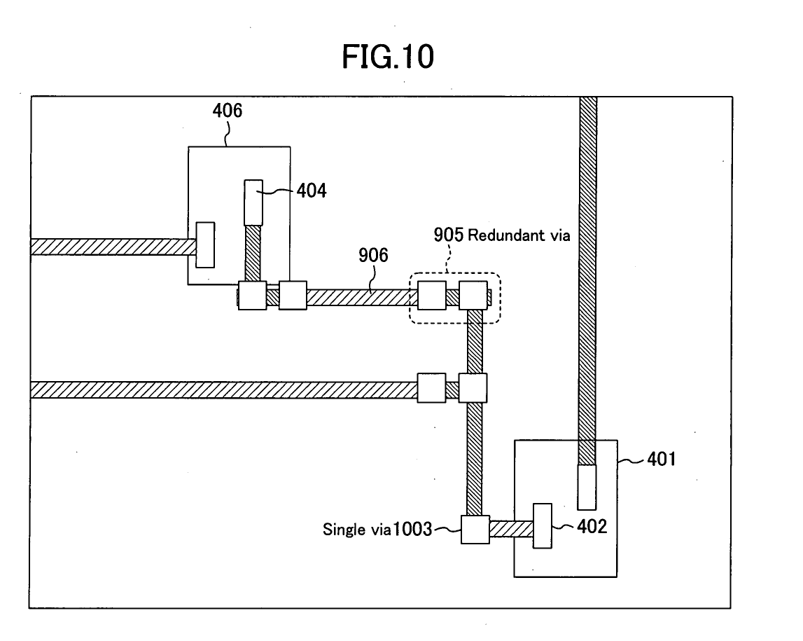

Results obtained from execution of the first embodiment will be described with reference to FIG. 9 and FIG. 10.

FIG. 9 illustrates layout data after redundant via conversion in which an output pin 402 of a standard cell 401 and an input pin 404 of a standard cell 403 are connected to each other by a redundant via 903 and a redundant via 905 each of which includes two vias, a wiring pattern 906 and the like. FIG. 10 illustrates a result of conversion of redundant vias to respective single vias in the order of design violations having occurred or at random until a design violation no longer occurs, when a design rule violation such as an antenna error and a timing constraint violation occurs in a signal line connecting the output pin 402 of the standard cell 401 and the input pin 404 of the standard cell 403 in the layout data of FIG. 9.

Thus, the redundant via 903 is converted to a single via 1003 and the occurrence of an antenna effect error, a timing constraint violation and the like can be avoided due to reduction in via area and the increase and decrease effect of a via resistance value.

As in FIG. 1, a design support system for performing the above-described processing receives post-redundant-via-conversion layout data, performs an error analysis, an error judgment and via conversion in computer processing, and outputs the post-redundant-via-conversion layout data.

According to this embodiment, problems with a design constraint violation such as a timing constraint violation or an antenna effect error caused by redundant via conversion can be improved in a simple manner and many redundant vias can be generated.

In this embodiment, the number of redundant vias with which a design constraint violation no longer occurs is calculated in the error judgment step S103. However, the number of redundant vias with which a design constraint violation no longer occurs may be calculated in the via conversion step S104.

### SECOND EMBODIMENT

Hereinafter, a second embodiment of the present invention will be described with reference to the accompanying drawings.

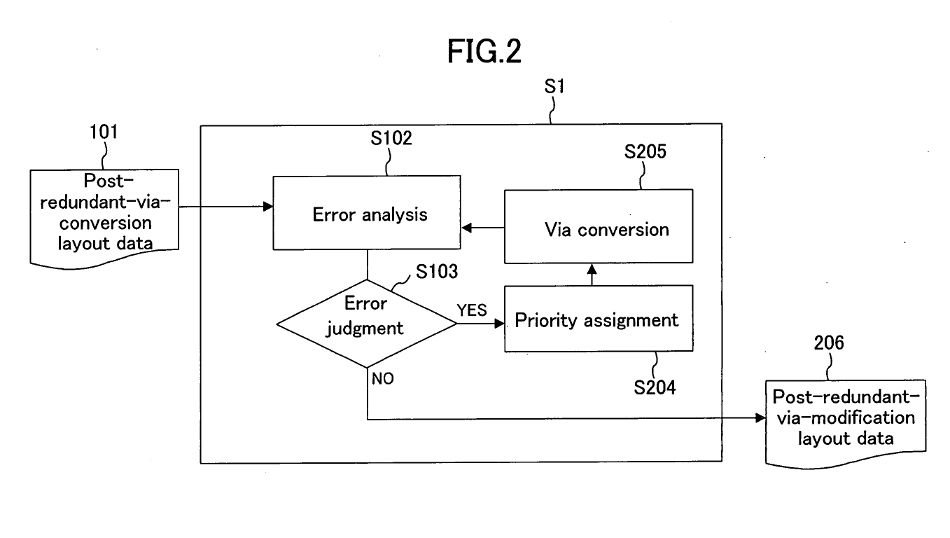

FIG. 2 is a diagram illustrating process steps using a method for designing a semiconductor device according to the second embodiment of the present invention.

In FIG. 2 illustrating this embodiment, as in FIG. 1 shown in the first embodiment, an error analysis for a timing constraint violation, an antenna effect error or the like is performed to post-redundant-via-conversion layout data 101 in the error analysis step S102 of the computer processing step 1 and an error judgment is performed for a result of the analysis in the error judgment step (judgment step) S103.

This embodiment is different from the first embodiment in that the priority assigning step (redundant via priority determination step) S204 of assigning priorities to errors such as an antenna effect error and a timing constraint violation caused by redundant vias being provided in descending order of a necessity of being set as a redundant via is inserted between the error judgment step S103 and the via conversion step S104 of FIG. 1 described in the first embodiment. In this embodiment, Step S205 is a conversion step in which redundant vias is converted to respective single vias based on a result of priority assigning to modify layout data. If it is judged that an error has not occurred in the error judgment step S103, layout data is output as post-redundant-via-conversion layout data 206 from the error judgment step S103.

Hereinafter, a method for designing a semiconductor device according to this embodiment which is used in the process steps set in the above-described manner will be described.

As in the first embodiment, an analysis of a design constraint violation (a predetermined constraint violation) such as a timing constraint violation or an antenna effect error is performed for the post-redundant-via-layout data 101 in the error analysis step S102.

Next, in the error judgment step S103, whether or not the design constraint violation exists is judged. In the error judgment step S103, if it is judged that an error such as an antenna effect error has not occurred, layout data is output as it is as the post-redundant-via-conversion layout data 206 and the process is terminated. However, if it is judged that an error has occurred, a redundant via reduction number (conversion number), i.e., the number of redundant vias which are to be converted to respective single vias to avoid a design constraint violation is calculated for each signal line, based on an error result. In this embodiment, the error judgment step S103 includes the calculation step of calculating the redundant via reduction number.

Thereafter, priorities are assigned to redundant vias on the signal line in which an error has occurred, in view of improving problems with a yield, electromigration and the like, in the priority assigning step S204.

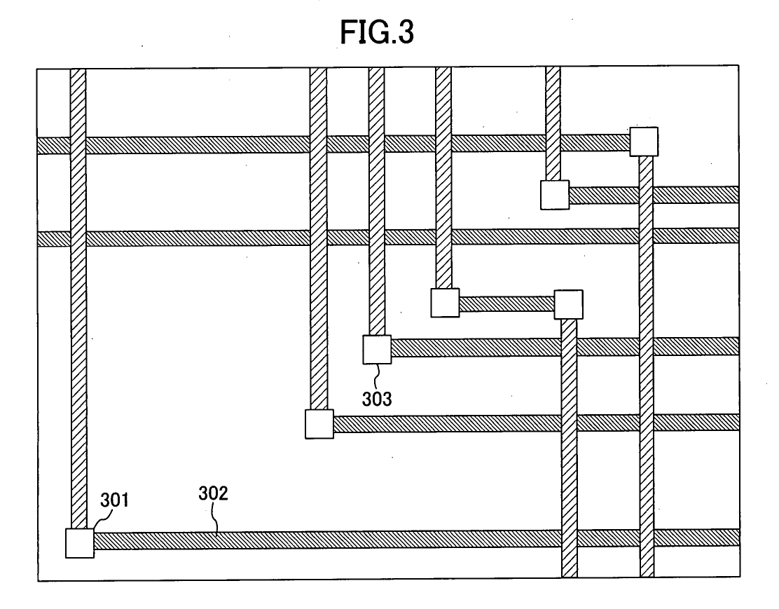

In FIG. 3, an example where priorities are determined in view of improving problems with a yield will be described. FIG. 3 illustrates a via 301 provided such that no other via exists in a short distance, i.e., and the via 301 is isolated, a wiring pattern 302 connected to another wire by the via 301 and a via 303 provided such that other vias exist in a short distance, i.e., the via 303 is not isolated. In consideration of fabrication yield, the incidence of defective vias of the case of the non-isolated via 303 is lower than that of the isolated via 301 and, accordingly, the necessity of conversion of the via 303 to a redundant via is low, compared to the via 301. Therefore, in view of improving problems with yield, it is judged that the non-isolated via 303 is given a lower priority in the priority assigning step S204 of FIG. 2.

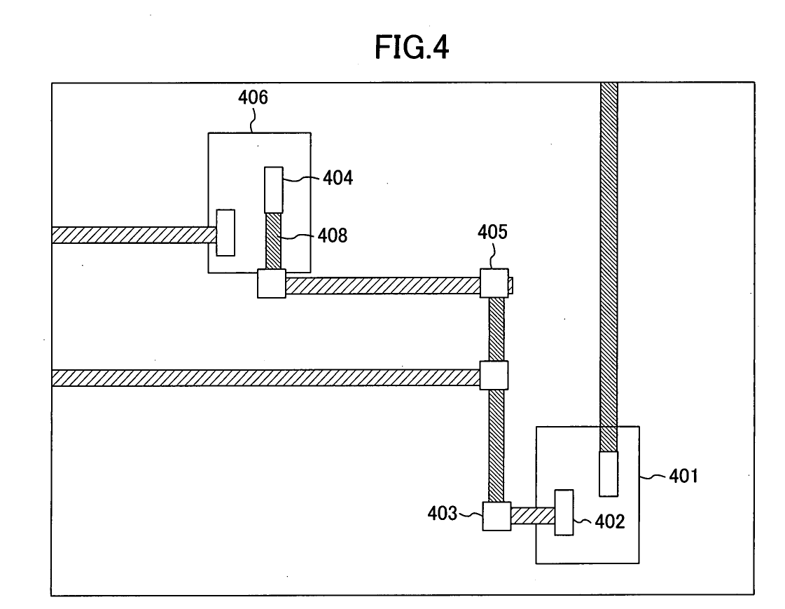

Subsequently, an example where priorities are assigned to redundant vias in consideration of the occurrence of electromigration will be shown in FIG. 4. When comparison between a via 403 located close to an output pin 402 in a standard cell 401 and a via 405 located close to a standard cell input pin 404 is made, electromigration occurs at higher rate in the via 403 located close to the output pin 402 and redundant via conversion should be conducted for the via 403. In view of improving problems due to electromigration, it is judged that the via 403 located close to the output pin 402 of the standard cell 401 has a higher priority in the priority assigning step S204 of FIG. 2.

For judgment information for priority assigning shown in FIG. 3 and FIG. 4, information is input from the outside in advance or information is stored in a computer program code in advance.

In the via conversion step S205, redundant vias are converted to single vias in ascending order from one of the redundant vias which has been judged as the lowest priority via in the priority assigning step S204. Thereafter, the same process is repeated until the number of redundant vias which belong to a single line in which an error such as an antenna effect error has occurred and have been converted to single vias reaches a redundant via reduction number calculated in the error judgment step S103 or all redundant vias belonging to a single line are converted to single vias. As another alternative, an error analysis is performed in the error analysis step S102 each time when a redundant via is converted to a single via and the error and, based on a result of the error analysis, the same process is repeated until an error no longer occurs in the error judgment step S103.

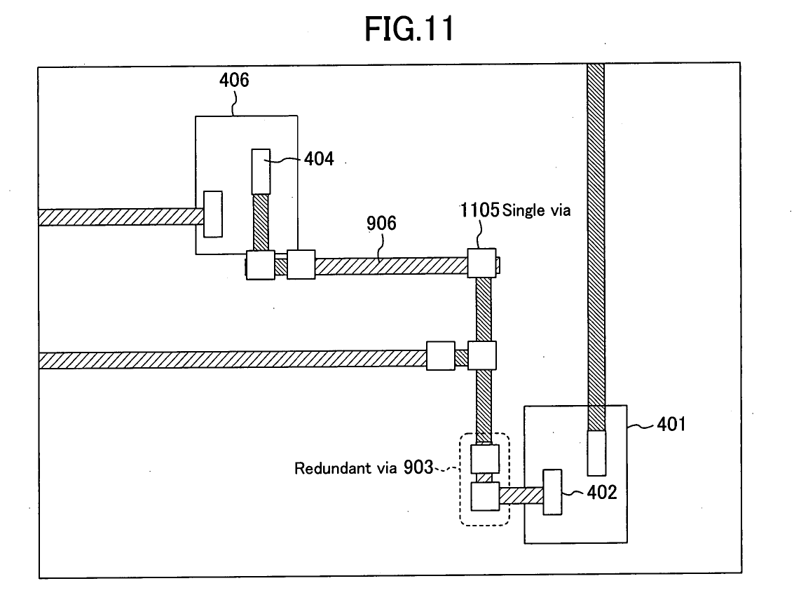

Results obtained from execution of the second embodiment will be described with reference to FIG. 9 and FIG. 11. FIG. 9 illustrates layout data after redundant via conversion in which an output pin 402 of a standard cell 401 and an input pin 404 of a standard cell 406 are connected to each other by a redundant via 903, a redundant via 905, a wiring pattern 906 and the like. FIG. 11 illustrates a result obtained after priorities are assigned to redundant vias in view of improving problems with yield, electromigration and the like and then redundant vias have been converted to respective single vias in ascending order of priority until a design violation no longer occurs, when a design rule violation such as an antenna error and a timing constraint violation occurs in a signal line connecting the standard cell output pin 402 and the standard cell input pin 404 in the layout data of FIG. 9. Thus, the redundant via 905 of FIG. 10 is converted to be a single via 1105 as shown in FIG. 11, so that the occurrence of an antenna effect error, a timing constraint violation and the like can be eliminated due to reduction in via area and the increase and decrease effect of a via resistance value. In the first embodiment, redundant vias are converted to respective single vias in the order of detection of the redundant vias or at random. In contrast, according to this embodiment, in view of yield, electromigration and the like, without conversion of the redundant via 903 which is assumed to be effective for improving problems to a single via, another redundant via can be converted to the single via 1105. Thus, problems with yield or electromigration are not caused, so that a redundant via with high necessity can be reliably maintained.

As in FIG. 2, a design support system for performing the above-described processing receives post-redundant-via-conversion layout data, performs an error analysis, an error judgment and via conversion in computer processing, and outputs the post-redundant-via-conversion layout data.

As described above, according to the second embodiment, in addition to the effects of the first embodiment, a redundant via can be left in an effective location in view of yield, electromigration and the like.

In this embodiment, the number of redundant vias with which a design constraint violation such as an antenna effect error no longer occurs is calculated in the error judgment step S103. However, the number of redundant vias with which a design constraint violation no longer occurs may be calculated in the priority assigning step S204 or the via conversion step S205.

Moreover, it has been described that after the first via conversion step S205, a series of process steps of the error analysis step S102, the error judgment step S103, the priority assigning step S204 and then the via conversion step S205 is repeated. However, conversion of redundant vias to respective single vias may be completed at a time point when the number of redundant vias has reached the number thereof with which a design rule violation such as an antenna effect and the like no longer occurs.

### THIRD EMBODIMENT

Hereinafter, a third embodiment of the present invention will be described with reference to the accompanying drawings.

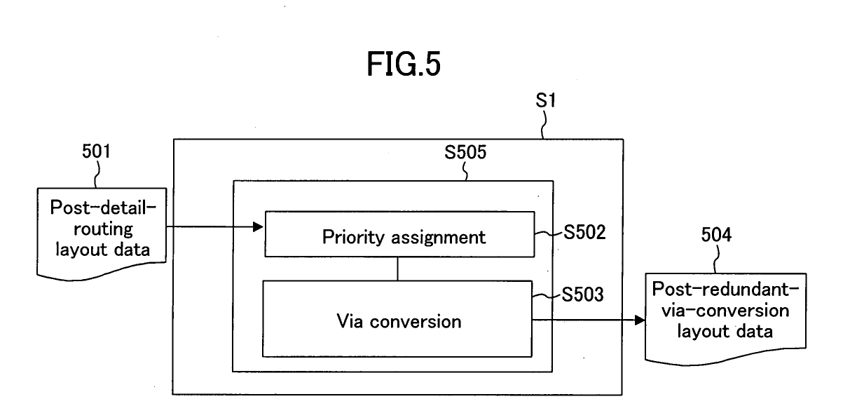

FIG. 5 is a diagram illustrating process steps using a method for designing a semiconductor device according to the third embodiment of the present invention.

In FIG. 5, the reference numeral 501 denotes post-detail-routing layout data, Step S502 denotes the priority assigning step of assigning priorities in layout data after detail routing which has been input with respect to conversion of a single via to a redundant via, Step S503 denotes the via conversion step of converting a single via to a redundant via based on a result of priority assignment in the priority assigning step S502, and the reference numeral 504 denotes the post-redundant-via-conversion layout data output after conversion of a single via to a redundant via in the via conversion step S503. Among the above-described steps, the redundant via conversion step S505 including the priority assigning step S502 and the via conversion step S503 is included in Step 1 performed by computer.

Hereinafter, a method for designing a semiconductor device according to this embodiment which is used in the process steps set in the above-described manner will be described.

In the priority assigning step S502, priorities are assigned single vias on a signal line in layout data 501 before redundant via conversion, in view of improving problems with yield, electromigration and the like. In this case, as for the priority assigning step S502, the same process is performed in the manner described in FIG. 3 and FIG. 4 of the second embodiment. Information used as reference for judgment in priority assignment is input from the outside in advance or such information is stored in a program code in computer.

In the priority assigning step S502, priorities are assigned to single vias in descending order of the necessity of conversion to redundant vias and the number of convertible single vias with which an antenna effect error is not caused is calculated. Then, according to the assigned priorities, each of single vias is converted to a redundant vias in order in the via conversion step S503.

Although not shown in the drawings, if a single via judged to have high priority is converted to a redundant via but a region for sufficient number of vias is not ensured around the single via, a surrounding wire is displaced so that a via generation region in which a single via can be converted to a redundant via is ensured.

Redundant via conversion is performed, in the same manner as in the known method, to single vias which are not applied to the information used as reference for judging priorities. As described above, unlike the redundant via conversion step S807 in the known method, the priority assigning step S505 is characterized by including the priority assigning step S502 and the via conversion step S503.

Results obtained from execution of the third embodiment will be described with reference to FIG. 11. According to this embodiment, as shown in FIG. 11, in a post-redundant-via-conversion layout, an output pin 402 of a standard cell 401 and an input pin 404 of a standard cell 406 are connected to each other by a wiring pattern 906, a single via 1105, a redundant via 903 and the like. In view of problems with yield, electromigration and the like, the redundant via 903 is obtained by converting a single via located in part in which conversion to redundant vias is likely to be highly effective in improving the problems, i.e., a single via connected to the output pin of the standard cell 401 to a redundant via.

As shown in FIG. 5, a design support system for performing the above-described processing receives post-detail-routing layout data 501, performs redundant via conversion characterized by including priority assignment and via conversion and outputs post-redundant-via-conversion layout data. Among the processes described above, priority assignment and via conversion are performed by computer.

In the second embodiment, priorities are assigned according to layout data which has already gone through redundant via conversion and then redundant vias are converted to respective single vias. Therefore, in part in which redundant via conversion has not been performed, a redundant via can not be provided even though it is likely that problems with yield, electromigration and the like are effectively improved in the part. In contrast, according to the third embodiment, it becomes possible to perform priority assignment in part where problems are likely to be effectively improved in view of yield, electromigration and the like in the step of redundant via conversion and also to convert single vias to redundant vias in descending order of priority. Redundant vias conversion can be reliably performed to a single via having high priority by dislocating a surrounding wiring pattern in a region in which redundant via conversion is needed.

The case where a wire surrounding a single via is dislocated in the via conversion step S503 has been described. However, this embodiment is applied in the same manner also in the case where such a surrounding wire does not have to be dislocated.

### FOURTH EMBODIMENT

Hereinafter, a fourth embodiment of the present invention will be described with reference to the accompanying drawings.

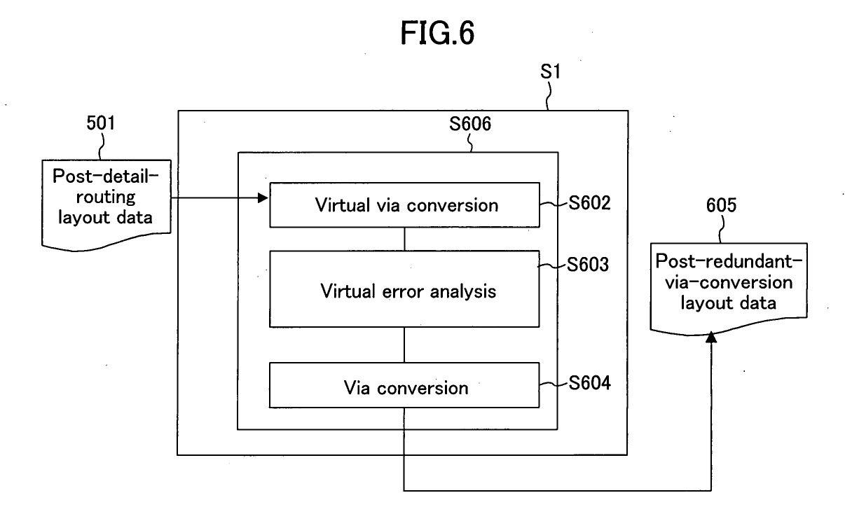

FIG. 6 is a diagram illustrating process steps using a method for designing a semiconductor device according to the fourth embodiment of the present invention.

In FIG. 6, the reference numeral 501 denotes post-detail-routing layout data, Step S602 is a virtual via conversion step, Step S603 is a virtual error analysis step, Step S604 is a via conversion step, the reference numeral 605 denotes post-redundant-via-conversion layout data which is obtained by redundant via conversion and then is output, Step S606 is a redundant via conversion step, and the reference numeral 1 denotes a processing step performed by computer.

Hereinafter, a method for designing a semiconductor device according to this embodiment which is used in the process steps set in the above-described manner will be described.

In the virtual via conversion step (virtual conversion step) S602, a single via is virtually converted to a redundant via for the post-detail-routing layout data 501. Next, in the virtual error analysis step (virtual analysis step) S603, analysis of a design constraint violation (a predetermined constraint violation) such as a violation of a timing constraint, an antenna effect error and the like is performed in a virtual state and a redundant via convertible number (convertible number), i.e., the number single vias which can be converted to redundant vias, respectively, without causing the design constraint violation is calculated for each signal line. In this embodiment, the virtual error analysis step S603 includes the step of calculating the number of convertible vias to redundant-vias.

Next, in the via conversion step S604, redundant via conversion is performed to single vias for each signal line so that the number of converted vias does not exceed the redundant via convertible number calculated for each signal line in the virtual error analysis step S603. As described above, unlike the redundant via conversion step S807 in the known method, the redundant via conversion step S606 is characterized by including the virtual via conversion step S602, the virtual error analysis step S603 and the via conversion step S604.

Results obtained from execution of the fourth embodiment will be described with reference to FIG. 10. According to this embodiment, as shown in FIG. 10, a post-redundant-via-conversion layout is layout data in which an output pin 402 of a standard cell 401 and an input pin 404 of a standard cell 406 are connected to each other by a wiring pattern 906, a redundant via 905, a single via 1103 and the like. In the virtual error analysis step S603, a virtual analysis of whether or not an error exists is performed to a result of virtual conversion of a single via to a redundant vias in the virtual via conversion step S602 to estimate the number of redundant vias which can be generated without causing an antenna effect error, a timing constraint violation and the like. According to a result of the estimation, among vias to which redundant via conversion can be performed, i.e., vias which do not cause problems due to reduction in yield and electromigration, only each of vias which do not cause an antenna effect error, a timing constraint violation and the like are converted to be the redundant via 905 and each of other vias is left as the single via 1003, i.e., a single via.

As in FIG. 6, a design support system for performing the above-described process steps receives post-detail-routing layout data, performs redundant via conversion characterized by including virtual via conversion, virtual error analysis and via conversion and outputs post-redundant-via-conversion layout data. The redundant via conversion is processed by computer.

According to the fourth embodiment, a single via can be virtually converted to a redundant via in advance before redundant via conversion and thus it becomes possible to estimate the occurrence of a timing constraint violation. Accordingly, before the number of actual redundant vias reaches the number of vias which virtually cause an error, conversion of a single via to a redundant via is cancelled. Thus, the occurrence of an antenna effect error and a timing constraint violation is not increased even after redundant via conversion, resulting in reduction in time of design for improving errors.

In this embodiment, the redundant via convertible number is calculated in the virtual error analysis step S603. However, the redundant via convertible number may be calculated in the via conversion step S604.

Moreover, in this embodiment, the redundant via conversion step S606 described in the fourth embodiment is performed with post-detail-routing layout data received as an input. However, the redundant via conversion step S606 may be performed during the detail routing step with post-global-routing layout data received as an input.

### FIFTH EMBODIMENT

Hereinafter, a fifth embodiment of the present invention will be described with reference to the accompanying drawings.

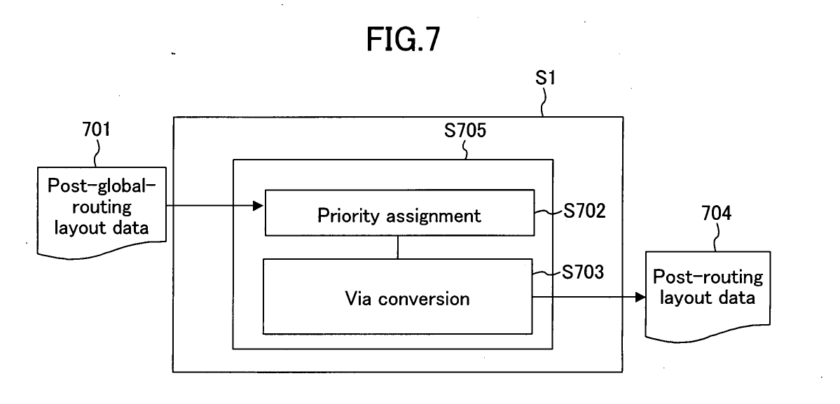

FIG. 7 is a diagram illustrating process steps performed by computer using a method for designing a semiconductor device according to the fifth embodiment of the present invention.

This embodiment is different from the third embodiment in the following point. In the process steps of FIG. 5, priority assignment and via conversion are performed to the post-detail-routing layout data 501, but priority assignment and via conversion are performed in the same manner to post-global routing layout data 701 in a process step of FIG. 7. Step S702 is a priority assigning step, Step S703 is a via conversion step, the reference numeral 704 denotes post-detail-routing layout data to be output, Step S705 is a detail-routing step including the priority assigning step S702 and the via conversion step S703, and the reference numeral 1 denotes a process step performed by computer.

Hereinafter, a method for designing a semiconductor device according to this embodiment which is used in the process steps set in the above-described manner will be described.

Detail routing is performed to the post-global routing layout data 701. The detail routing is largely divided into the step of generating a wiring pattern on a pathway and the step of generating a via for connecting wiring patterns formed in different wiring layers. Each time when a new single via is generated for each wire during the via generation step, or at a time when the generation of all vias is completed, the number of convertible vias to redundant vias, respectively, is calculated (the calculating step) in view of improving problems with yield, electromigration and the like in the priority assigning step (single via priority determination step) S702 and priority assignment in which priorities are assigned to signal vias in descending order of the necessity of conversion to redundant vias. In this case, an example of priority assignment in view of yield, electromigration and the like is the same as the example described in the second embodiment with reference to FIG. 3 and FIG. 4. As for information used for judgment of priority assignment of redundant vias, information is input in advance from the outside or information is stored in advance in a program code in computer.

In the via conversion step S703, single vias are converted to redundant vias, respectively in descending order from a single via judged to have a high priority in the priority assigning step S702. In this case, if the single via judged to have a high priority is converted to a redundant via and a region for a sufficient number of vias is not ensured around the single via, a surrounding wire is dislocated in the detail-wire-routing step following the via conversion step. Thus, a via generation region in which a single via can be converted to a redundant via is ensured. Moreover, as for single vias which are not applied to information used as reference for judging priorities, only vias which can be converted within the range where wire formation rules are satisfied are converted to redundant vias, respectively. As described above, the detail routing step S705 is characterized by including, in addition to the known detail routing step S806, the priority assigning step S702 and the via conversion step S703.

Results obtained from execution of the fifth embodiment will be described with reference to FIG. 11. According to this embodiment, as shown in FIG. 11, a post-redundant-via-conversion layout is layout data in which an output pin 402 of a standard cell 401 and an input pin 404 of a standard cell 406 are connected to each other by a wiring pattern 906, a single via 1105, a redundant via 903 and the like. In this case, a redundant via obtained by converting a single via located in part in which conversion to a redundant via is likely to be highly effective in view of improving problems with yield, electromigration and the like is shown as the redundant via 903.

As shown in FIG. 7, a design support system for performing the above-described processing includes the input step 701 of inputting post-global routing layout data, the detail-routing step S705 characterized by including the priority assigning step S702 and the via conversion step S703 and the output step 704 of outputting post-detail-routing layout data. Among the processes described above, the detail routing step S705 is a process step 1 performed by computer.

By implementing this embodiment, unlike the known method, priorities can be assigned to single vias located in effective parts not after detail routing but during detail routing in view of improving problems with yield, electromigration and the like. Moreover, the detail routing step S705 includes the priority assigning step S702 and the via conversion step S703. Thus, a pathway can be flexibly changed in a wider range than that in the third embodiment. Accordingly, a region in which a sufficient number of redundant vias are generated can be ensured in a simple manner, so that an increased number of redundant vias can be generated in effective parts in view of improving problems with yield, electromigration and the like.

1. A semiconductor device design method for designing by computer a layout of a semiconductor device including redundant vias each of which is obtained by converting each of single vias each connecting wires in different wiring layers to two or more vias, the method comprising:
a judgment step of performing judgment of whether or not a predetermined constraint violation caused by each of the redundant vias exists to layout data including the redundant vias;
a calculating step of calculating, if it is judged that the predetermined constraint violation exists in the layout data in the judgment step, a minimum conversion via number of the redundant vias to be converted to the respective single vias so that the predetermined constraint violation is resolved; and
a conversion step of converting ones of the redundant vias to ones of the single vias, respectively, according to the conversion via number obtained in the calculating step.

2. The method of claim 1, wherein in the conversion step, ones of the redundant vias belonging the layout data in which the predetermined constraint violation has occurred are detected and then converted to the single vias, respectively, one by one in the order of the detection.

3. The method of claim 1, wherein arbitrary vias are selected from all the redundant vias at random so that the number of the selected redundant vias corresponds to the conversion via number calculated in the calculating step and then the selected redundant vias are converted to ones of the single vias, respectively, one by one.

4. The method of claim 2, wherein in the conversion step, based on the conversion via number calculated in the calculating step, conversion to a single via is repeatedly performed to the redundant vias in each signal line including the redundant vias until the predetermined constraint violation no longer exists.

5. The method of claim 1, further comprising:
a redundant via priority determination step of assigning priorities to all of the redundant vias in the conversion step in descending order of a necessity of redundant via conversion,
wherein in the conversion step, conversion to a single via is performed to the redundant vias in ascending order of the priories assigned in the redundant via priority determination step.

6. The method of claim 5, wherein in the redundant via priority determination step, among the redundant vias, a redundant via located a longer distance from another redundant via is given a lower priority.

7. The method of claim 5, wherein in the redundant via priority determination step, among the redundant vias, a redundant via located on a wire in which the number of the occurrence of electromigration is smaller is given a lower priority.

8. The method of claim 5, wherein the redundant via priorities are input from the outside, and
wherein in the redundant via priority determination step, the redundant via priorities input from the outside are assigned to all of the redundant vias.

9. The method of claim 1, wherein the redundant via priorities are stored in advance in a program code in computer, and
wherein in the redundant via priority determination step, the redundant via priorities stored in the program code in the computer are assigned to all of the redundant vias.

10. A semiconductor device design method for designing by computer a layout of a semiconductor device including redundant vias each of which is obtained by converting each of single vias each connecting wires in different wiring layers to two or more vias, the method comprising:
a virtual conversion step of virtually converting ones of the single vias to ones of the redundant vias, respectively;
a calculating step of calculating, for the layout data obtained in the virtual conversion step and including the redundant vias, a convertible number of the redundant vias which can be converted from the single vias, respectively, without causing a predetermined constraint violation; and
a conversion step of generating, based on the convertible number of the redundant vias obtained in the calculating step, the redundant vias by conversion of the single vias.

11. A semiconductor device design method for designing by computer a layout of a semiconductor device including redundant vias each of which is obtained by converting each of single vias each connecting wires in different wiring layers to two or more vias, the method comprising:
a calculating step of calculating, for the layout data including the single vias, a convertible number of the redundant vias which can be converted from respective single vias without causing a predetermined constraint violation;
a single via priority determination step of assigning priorities to all of the single vias corresponding to the convertible number calculated in the calculating step in descending order of a necessity of redundant via conversion; and
a conversion step of performing redundant via conversion to the single vias in descending order of priority determined in the single via priority determination step.

12. The semiconductor device design method of claim 11, wherein in the single via priority determination step, each time when a single via is generated, a single via priority is assigned to the single via during detail routing performed to post-global-routing layout data.

13. A semiconductor device fabricated according to the semiconductor device design method of claim 1.

14. The method of claim 1, further comprising:
a manufacturing step of producing LSI chips based on the layout design data.

15. A semiconductor device fabricated according to the semiconductor device design method of claim 2.

16. A semiconductor device fabricated according to the semiconductor device design method of claim 3.

17. A semiconductor device fabricated according to the semiconductor device design method of claim 4.

18. A semiconductor device fabricated according to the semiconductor device design method of claim 5.

19. A semiconductor device fabricated according to the semiconductor device design method of claim 6.

20. A semiconductor device fabricated according to the semiconductor device design method of claim 7.

21. A semiconductor device fabricated according to the semiconductor device design method of claim 8.

22. A semiconductor device fabricated according to the semiconductor device design method of claim 9.

23. A semiconductor device fabricated according to the semiconductor device design method of claim 10.

24. A semiconductor device fabricated according to the semiconductor device design method of claim 11.

25. A semiconductor device fabricated according to the semiconductor device design method of claim 12.
